(19) United States
(12) Patent Application Publication
(10) Pub. No.: US 2014/0224569 A1
(43) Pub. Date: Aug. 14, 2014

(54) Reflex Tube for a Ported Speaker

(71) Applicant: Pellisari, LLC, Encinitas, CA (US)

(72) Inventor: Francesco Pellisari, Rome (IT)

(73) Assignee: Pellisari, LLC, Encinitas, CA (US)

(21) Appl. No.: 14/179,315

(22) Filed: Feb. 12, 2014

Related U.S. Application Data
(60) Provisional application No. 61/764,261, filed on Feb. 13, 2013.

(51) Int. Cl. H04R 1/28

(52) U.S. Cl. CPC H04R 1/2807
USPC 181/156

(57) ABSTRACT

The inventive subject matter provides a reflex tube for a speaker enclosure and a speaker enclosure that includes a reflex tube, where the reflex tube includes one or more cables and/or connections disposed within it. The connection may be affixed to a connection support, which is in turn affixed within the reflex tube. The connection support may be utilized to reduce air turbulence within the reflex tube.

### FIELD OF THE INVENTION

The field of the invention is audio speakers with reflex ports or reflex tubes, in particular bass reflex speakers.

### BACKGROUND

A speaker enclosure is a cabinet or enclosure that houses one or more speaker drivers, associated electronic (such as crossover circuits and amplifiers), and connections that supply power and audio signals to the device. Although generally configured as rectangular enclosures, speaker enclosures are also available in a wide variety of shapes. Such shapes include spheres, ovoids, tear-drop shapes, or any one of a wide variety of curved or curvilinear configurations as suits the functional needs and esthetic desires of the designer. Speaker enclosures may also incorporate internal baffles, reflex ports or tubes, and acoustic insulation in order to improve acoustic performance.

In general, the cables and connections that supply power and sound or audio signals to a speaker enclosure are mounted in openings that are made through a wall of the speaker enclosure. Such openings may be drilled through the material of the wall, or may be molded into the wall during the manufacturing process. Unfortunately, such openings can negatively impact the acoustic performance of the speaker through the loss of sound energy through such openings and by interfering with the reflection of sounds within the speaker enclosure. In addition, mounting such a fashion leaves the cables and connections that provide inputs to the speaker enclosure exposed. Not only is this esthetically undesirable, such exposure renders these components susceptible to environmental damage, for example through collisions. In addition, the curved or curvilinear walls of nontraditional speaker enclosures (such as spheres or ovoids) can complicate drilling and/or molding of such openings.

Numerous speaker enclosures that utilize wireless connections, such as Bluetooth or WiFi technologies, in order to provide an audio signal without the use of a cable or wall-mounted connection are commercially available. The quality of the audio signal in such implementations, however, may suffer due to the relative lack of bandwidth required for accurate reproduction of sound across the audible range. While this may be addressed in part through the use of compression algorithms, reduced quality of the reproduced sound may be apparent to a discerning listener. In addition, such speaker enclosures still rely on connections that are mounted in openings in the speaker enclosure wall to supply power to the device.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for an speaker enclosure that incorporates a cable and/or a connections in a protected fashion and wherein the cable and/or connection does not interfere with sound reproduction the speaker, in particular where the use of curved and/or curvilinear speaker enclosure shapes is desirable.

### SUMMARY OF THE INVENTION

The inventive subject matter provides apparatus, systems and methods in which one can secure one or more cable(s) and/or connection(s) (such as a power cable/connection, an audio signal cable/connection, and/or a data cable/connection) to a speaker enclosure, by disposing of such a cable or connection within a reflex tube of the speaker enclosure. A connection may be affixed to a connection support, which is in turn affixed within the lumen of the reflex tube.

In one embodiment of the inventive concept a cable and/or a connection is disposed within a reflex tube of a speaker enclosure. Such speaker enclosures may include an outer housing or wall that is approximately spherical or approximately ovoid. In such an embodiment an audio signal may pass through the reflex tube, for example via an audio cable or connection (such as, for example, an audio cable or audio jack). Similarly, input and/or output power may pass through the reflex tube, for example via a power cable or connection. Exemplary power connections include a DC output connection and a PW DC power jack.

In some embodiments of the inventive concept a reflex tube may include a connection support that is disposed within the reflex tube. One or more connections may be affixed to such a connection support. In such embodiments, the connection support may be configured to reduce air turbulence within the reflex tube.

### BRIEF DESCRIPTION OF THE DRAWINGS

FIG. 1 is a representation of a reflex tube of the inventive concept. FIG. 1A depicts a lateral view of a reflex tube with associated cables. FIG. 1B depicts a lateral view of a reflex tube with associated connections.

FIG. 2 shows another reflex tube of the inventive concept. FIG. 2A shows a lateral view of a reflex tube with a support that carries connections. FIG. 2B shows views through the lumens of reflex tubes with different connection support configurations.

FIG. 3. is a representation of a speaker enclosure of the inventive concept. FIG. 3A depicts an approximately spherical speaker enclosure with a reflex tube that has cables disposed within it. FIG. 3B depicts an approximately ovoid speaker enclosure with a reflex tube that includes connections on a connection support.

### DETAILED DESCRIPTION

It should be noted that while the following description is drawn to a reflex tube and a speaker enclosure with a reflex tube, various alternative configurations are also deemed suitable and may employ various auditory devices including ultrasonic emitters, infrasound emitters, ultrasonic mixers, diagnostic ultrasound devices, emitters for sonar apparatus, and other sound-based devices, individually or collectively. One should appreciate that embodiments of the inventive concept may operate as discrete units or may be integrated into devices such as, for example, media players, external sound systems for media players (either directly or wirelessly connected), televisions, handheld and/or console gaming systems, telephones, and personal computing devices.

It should be appreciated that the disclosed devices and techniques provide many advantageous technical effects including improving the performance of speaker enclosures by elimination of unnecessary openings in an enclosure wall, reducing the complexity of manufacturing curved and/or curvilinear speaker enclosures, provision of protection for sound or audio signals, power, and other connections of and to speaker enclosures, and improving the esthetics of speaker enclosures by concealing such connections.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The inventive subject matter provides apparatus, systems and methods in which one may safely and discretely provide cables and/or connections for power, sound or audio signal, data, and other inputs and/or outputs to a speaker enclosure by providing such cables and/or connections within a reflex tube of the speaker enclosure. Such speaker enclosures may be, for example, spherical or approximately spherical, ovoid or approximately ovoid, tear drop shaped, or any suitable configuration that may be represented by rotation or extension of a curve or arc. Cables may include audio signal cables, power input cables, and power output cables. Connections may be in the form of terminals, plugs, sockets, jacks, posts, blades, rings, and/or spades. Alternatively, connections may be in the form of composite and/or hybrid connectors that combine a plurality of connections and/or connection types into a single fixture. Typical connections include, but are not limited to, input power connections, output power connections, audio signal connections, USB connectors, and dock connectors. In some embodiments of the inventive concept the connections can include a 3.5 mm jack utilized for a sound or audio signal, a DC output power jack, and/or a standard PW DC jack for an external power supply.

In conventional speaker enclosures such cables and/or connections are typically installed in holes, channels, or similar openings that are machined or molded into a wall of the speaker enclosure. Unfortunately, such openings can negatively affect the auditory performance of such speaker enclosures and may be difficult to manufacture in enclosures with curved and/or curvilinear walls (such as, for example, spherical or approximately spherical speaker enclosures).

Disposing such cables and/or connections in a reflex tube of a speaker enclosure advantageously eliminates the need for such openings in the speaker enclosure wall or housing.

In one embodiment of the inventive concept, one or more cable(s) may pass through the lumen of a reflex tube. Such cables may lie freely within the reflex tube, or, alternatively, may be affixed to the interior of the reflex tube at one or more points along their length. Similarly, one or more connection(s) may be affixed within a lumen of a reflex tube and/or affixed directly to an interior surface of a reflex tube. In other embodiments of the inventive concept, one or more connection (s) may be affixed to one or more intermediate structure(s) (such as, for example, a connection support) that is (are) in turn placed within a lumen of a reflex tube and/or affixed to an interior surface of a reflex tube.

In some embodiments of the inventive concept, a connection may be affixed (either directly or indirectly) at a position within a reflex tube such that it may be readily accessed by a user, while concealing the connection from view when the speaker enclosure is in normal use. In one embodiment of the inventive concept, a connection may be affixed from about 0.5 cm to about 10 cm from an external opening of a reflex tube. In another embodiment of the inventive concept, a connection may be affixed from about 1 cm to about 7.5 cm from an external opening of a reflex tube. In yet another embodiment of the inventive concept, a connection may be affixed from about 2 cm to about 5 cm of an external opening of a reflex tube. This advantageously improves the esthetics of the speaker enclosure, and additionally provides protection of such a connection, complementary connection, and/or an associated cable from accidental collisions.

Connection supports of the inventive concept may be configured to permit movement of air through the reflex tube. For example, a connection support of the inventive concept can be a crosspiece with one or more terminus(i) that is(are) affixed to an interior wall of a reflex tube. Such a crosspiece may have 1, 2, 3, or 4 or more members. Alternatively, a connection support of the inventive concept may be constructed, at least in part, of a porous and/or mesh material that permits movement of air while providing support for one or more connection(s). It should be appreciated that such air movement may serve, advantageously, to remove heat generated at a connection (such as, for example, a power connection) associated with a reflex tube of the inventive concept, thereby providing cooling of such components.

In some embodiments of the inventive concept a connection support may be configured to reduce air turbulence within a reflex tube when the speaker enclosure is in use. For example, a connection support may have dimensions, material composition, surface features, and/or streamlining features that promote laminar air flow and/or reduce vortex formation within the reflex tube. Reduction of air turbulence within a reflex tube advantageously reduces a source of auditory distortion in a speaker enclosure.

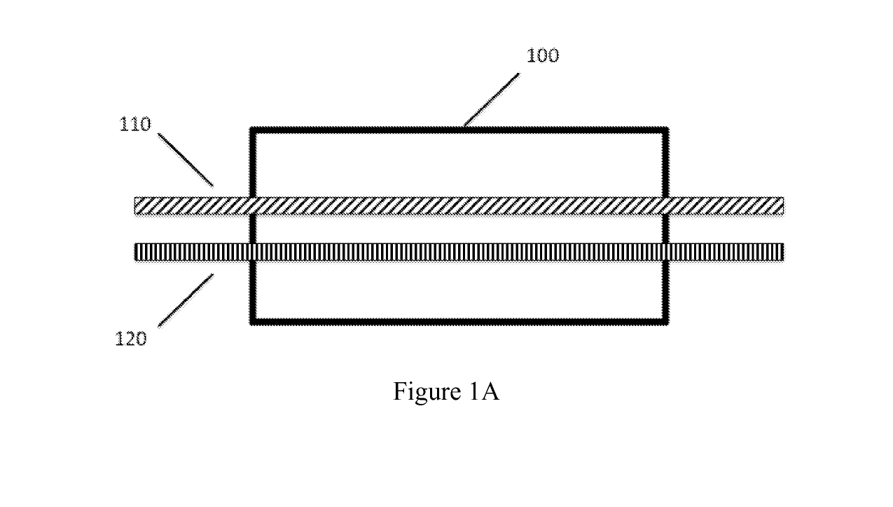

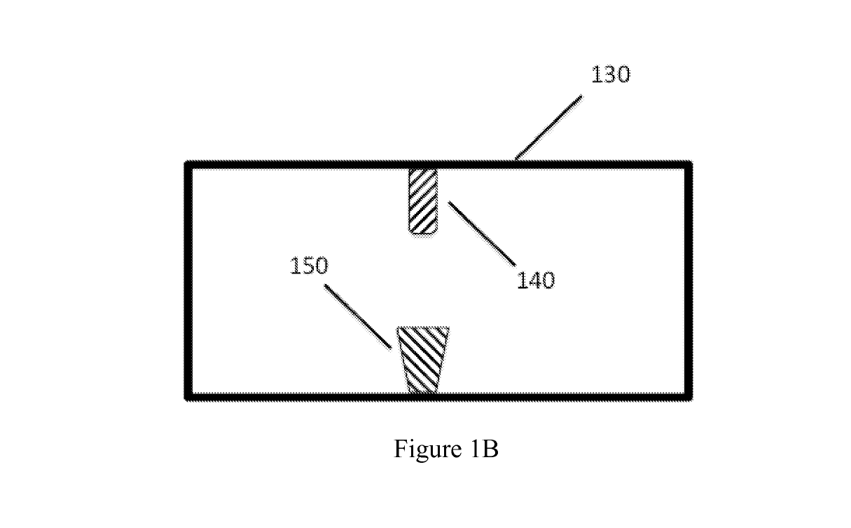

An example of a reflex tube of the inventive concept is shown in FIGS. 1A and 1B. In FIG. 1A, a reflex tube 100 is shown with a first cable 110 and a second cable 120 within the lumen of the reflex tube 100. Such a reflex tube may have an approximately circular cross section, however embodiments of the inventive concept in which a reflex tube has an elliptical and/or polygonal cross section are also contemplated. A reflex tube of the inventive concept may have an essentially linear major axis. Alternatively, a reflex tube of the inventive concept may have one more curves or bends along its length, or may describe a spiral and/or coiled path. In some embodiments of the inventive concept the geometry of a reflex tube may vary along one or more of its axes. The reflex tube 100 is shown with two cables (110, 120), however embodiments with a single cable and with three or more cables are also contemplated.

Another embodiment of the inventive concept is shown in FIG. 1B. In FIG. 1B, a reflex tube 130 is shown with a first connection 140 and a second connection 150 affixed within the lumen of the reflex tube 130. The reflex tube 103 is shown with two connections (140, 150), however embodiments with a single connection and with three or more connections are also contemplated. In some embodiments of the inventive concept, the connection or a subset of the connections may have identical functions. Alternatively, each connection associated with a reflex tube may have a different function. It is also contemplated that in some embodiments of the inventive concept, one or more cables and one or more connections may be disposed within a reflex tube.

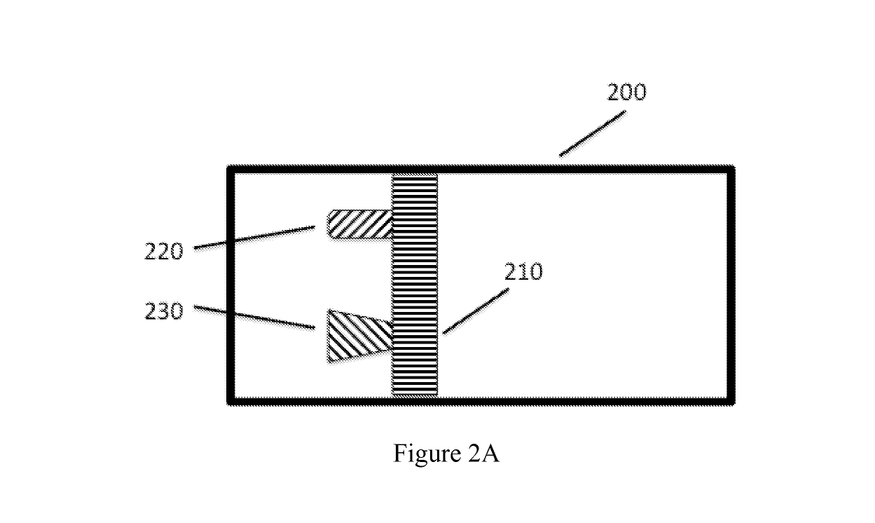

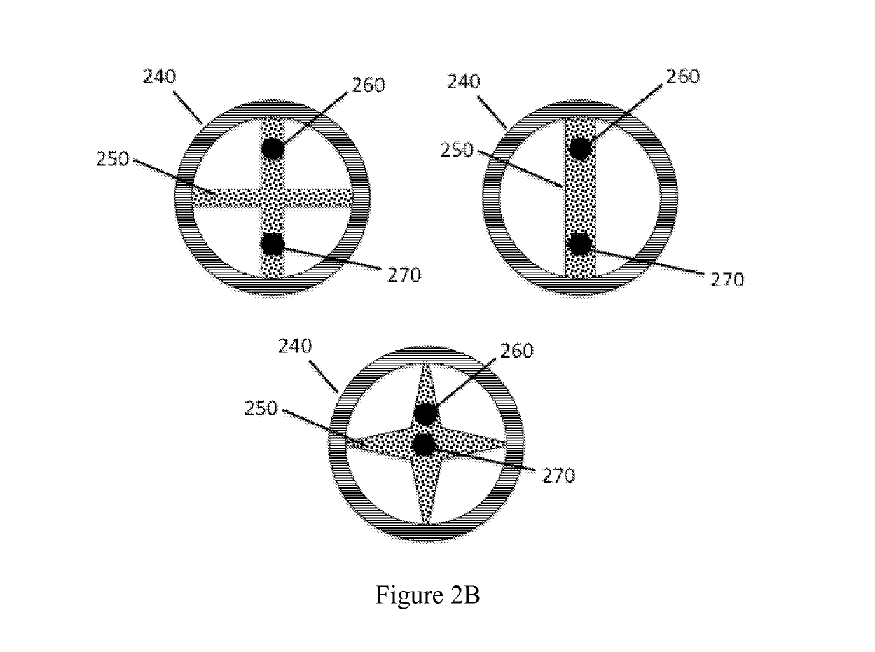

An example of another reflex tube of the inventive concept is shown in FIGS. 2A and 2B. FIG. 2A shows a lateral view of a reflex tube 200 that includes a connection support 210. The connection support 210 lies within the lumen of the reflex tube and is affixed to an interior wall of the reflex tube. A first connection 220 and a second connection 230 are affixed to the connection support. The reflex tube 200 is shown with two connections (220, 230), however embodiments with a single connection and with three or more connections are also contemplated. In some embodiments of the inventive concept, the connection or a subset of the connections may have identical functions. Alternatively, each connection associated with a reflex tube may have a different function. Exemplary connection supports are shown in FIG. 2B, in which similar components are designated by the same index number. In FIG. 2B, a reflex tube 240 includes a connection support 250 that is placed within the lumen of the reflex tube 240. A plurality of connections (260, 270) are affixed to the connection support 250. As shown, a connection support 250 may have one or more crosspieces. In some embodiments, as shown in the lower illustration, the connection support 250 can include streamlining features that serve to reduce air flow within the reflex tube. Connections may be distributed among the crosspieces of a connection support. Alternatively, one or more connections may be affixed centrally or approximately centrally on the connection support. For example, a connection that experiences significant stress may be affixed to a central portion of a connection support in order to provide additional mechanical support.

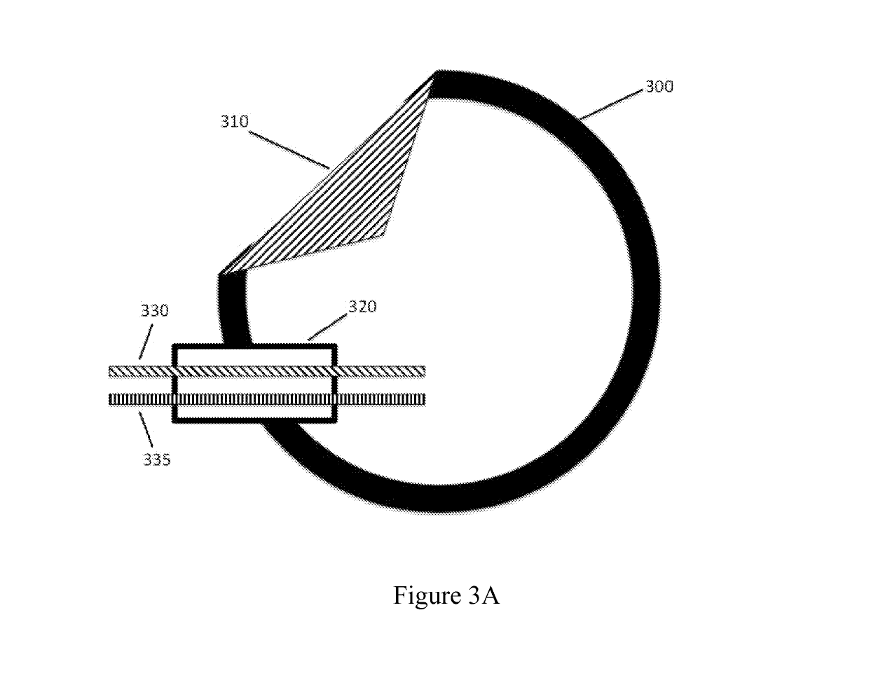

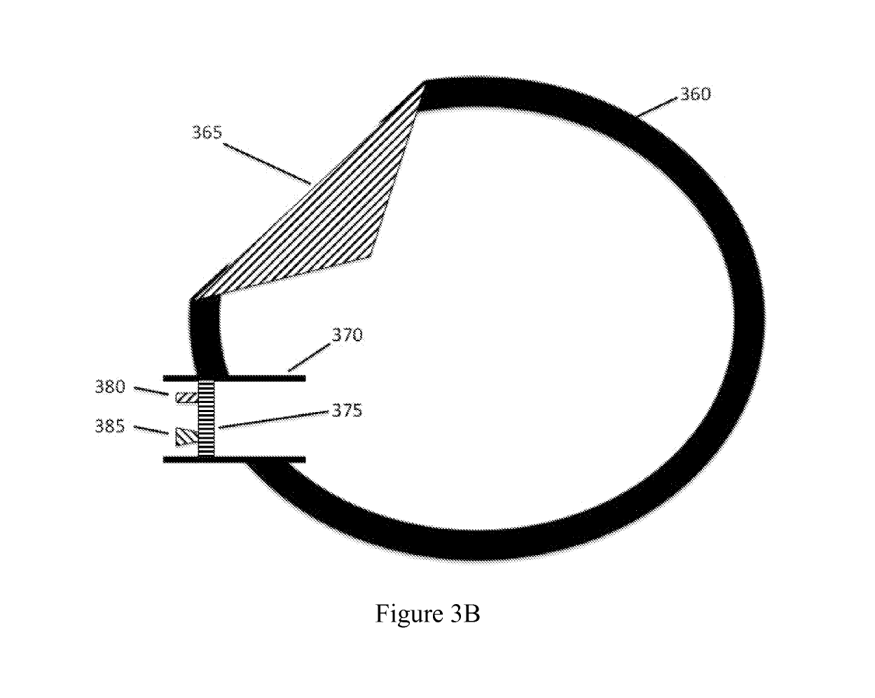

In still other embodiments of the inventive concept a speaker enclosure may incorporate one or more reflex tube(s) such as those described above. Such a speaker may be spherical or approximately spherical, ovoid or approximately ovoid, have a configuration that approximates a revolution and/or extension of a curve or arc, and/or have one or more walls with a curved or curvilinear configuration. Examples of such an embodiment are shown in FIGS. 3A and 3B. FIG. 3A depicts a speaker enclosure 300 which has an outer housing that is approximately spherical, and that includes a speaker driver 310 and a reflex tube 320 (similar to that shown in FIG. 1A). The reflex tube 320 includes a plurality of cables (330, 335) that may pass an audio signal, input power, and/or output power through the reflex tube 320. It should be noted that placement of the cables (330, 335) within the reflex tube 320 can provide protection for the cables and associated connections from debris and accidental collision. In addition, such placement may serve to conceal at least a portion of the cables from view, thereby improving the esthetics of the speaker system. Although the reflex tube 320 is shown beneath the speaker driver 310, it is also contemplated that a reflex tube 320 may be mounted in a position that at least partially opposes the speaker driver 310.

Another example of an embodiment of the inventive concept is shown in FIG. 3B. FIG. 3B depicts a speaker enclosure 360 which has an outer housing that is approximately ovoid, and that includes a speaker driver 365 and a reflex tube 370 (similar to that shown in FIG. 2A). The reflex tube 370 includes a plurality of connections (380, 385) that may pass an audio signal, input power, and/or output power through the reflex tube 370. The connections (380, 385) are affixed to a connection support 375 that is mounted within the lumen of the reflex tube 370. It should be noted that placement of the connections (380, 385) within the reflex tube 370 can provide protection for the cables and associated connections from debris and accidental collision. Such placement may also serve to at least partially conceal connections from view during use of the speaker enclosure, thereby improving it esthetics. In order to facilitate coupling of connection associated with a reflex tube of the inventive concept with complementary connections, the connection support may be affixed in proximity to an outer opening of the reflex tube 370.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A speaker enclosure having a reflex tube, and a cable disposed within the reflex tube.

2. A speaker enclosure having a reflex tube, and a connection disposed within the reflex tube.

3. The speaker enclosure of claim 1 or claim 2, wherein an audio signal passes through the reflex tube.

4. The speaker enclosure of claim 1 or claim 2, wherein a power input passes through the reflex tube.

5. The speaker enclosure of claim 1 or claim 2, wherein a power output passes through the reflex tube.

6. The speaker enclosure of claim 1 or claim 2, wherein the speaker enclosure further comprises an outer housing with a spherical configuration.

7. The speaker enclosure of claim 1 or claim 2, wherein the speaker enclosure further comprises an outer housing with an ovoid configuration.

8. The speaker enclosure of claim 2, wherein the connection is selected from the group consisting of an audio jack, a DC output connection, and a PW DC power jack.

9. The speaker enclosure of claim 2, further comprising a connection support disposed within the reflex tube.

10. The speaker enclosure of claim 9, wherein the connection is affixed to the connection support.

11. The speaker enclosure of claim 9, wherein the connection support is configured to reduce air turbulence within the reflex tube.
